(19) United States
(12) Patent Application Publication
(10) Pub. No.: US 2001/0002471 A1
(43) Pub. Date: May 31, 2001

(54) System and program for processing special characters used in dynamic documents

(76) Inventor: Isamu Ooish, Shizuoka (JP)

Correspondence Address: STAAS & HALSEY LLP, 700 11TH STREET, NW, SUITE 500, WASHINGTON, DC, 20001, US

(21) Appl. No.: 09/756,226

(22) Filed: Jan. 9, 2001

Related U.S. Application Data
(63) Continuation of application No. PCT/JP98/05927, filed on Dec. 24, 1998.

(30) Foreign Application Priority Data
Aug. 25, 1998 (JP) 10-238128

(51) Int. Cl. G06F 15/00; G06F 17/21; G06F 17/00; G06F 17/24

(52) U.S. Cl. 707/501; 707/526

(57) ABSTRACT

A system which processes special characters used in a dynamic document in real time to make them viewable at a remote computer system. A special character image management unit is employed in a general purpose computer to manage the special characters used in its database. Inside this management unit, a special character definition unit determines which special characters to convert into graphic images, thus creating a special character database file. Graphic images of those special characters are produced by a special character image generator, based on a character pattern dictionary containing character patterns. The produced special character image files form a special character image dictionary, which is transferred to a document conversion unit in a server machine, together with the special character database file. Using the special character database file, a special character identification unit identifies special characters used in a given source document, while a font size tracking unit keeps track of the current font size in the document. For each special character appearing in the source document, a link generator produces a link to a relevant image file. Finally, a compilation unit generates an output file, replacing every special character with a link to its corresponding image file.

### BACKGROUND OF THE INVENTION

1. Field of the Invention

The present invention relates to a system and program which process special characters used in dynamic documents. More particularly, the present invention relates to a system which correctly displays special characters appearing in a document that is compiled dynamically, as in the Internet web pages, and also to a computer-readable medium storing a program designed therefor.

2. Description of the Related Art

The Internet is used by many individuals and organizations as a powerful medium for making various information public. In particular, web search and database access services are popular network applications of today. With those services, people can find world wide web (WWW) pages that match with their interest by entering some specific keywords. Or they can retrieve desired information from a particular database by specifying appropriate search keywords. The servers for such services are designed to dynamically create a temporary web page for the users to view the search results.

Many companies, on the other hand, have constructed their own databases on the basis of host computers, or mainframes, for business purposes. Those databases would be a precious resource if they are accessible to network users through the above-described information retrieval services. Such mainframe database systems, however, are primarily for use in a local group environment, such as corporate LANs, and for this reason, they often use various special characters or user-defined characters to meet the need in the group, besides the standard character sets such as the Japanese Industrial Standards (JIS) level-1 and level-2 fonts in the case they are based on a Japanese-capable computer platform. To support those characters in a mainframe environment, appropriate character coding systems such as the Japanese processing Extended Feature (JEF) code have been used.

On the other hand, WWW servers in the Internet environment are required to operate with a system-independent interface because they have to serve various kinds of client systems, including personal computers. If non-standard character codes were used in a web page, they would become garbled at some client computers which do not support those characters. For this reason, most web pages avoid using such special characters, but use graphic images instead. Another problem in the Internet environment is the presence of a plurality of different character coding systems. More specifically, WWW servers normally use the Extended UNIX Code (EUC), while most Japanese-capable personal computers use the Shift-JIS code. Such a difference in the coding systems sometimes causes a problem of garbled characters.

As a general rule, it is not recommended to use system-dependent special characters in a document intended for exchange over the network. This rule should be considered in designing web pages, because such non-standard characters would not appear on a remote computer without the exact set of special character patterns, or they would be garbled if their codes are assigned to other character patterns. When it is absolutely necessary to use a special character, the web designer paste it on the document as an embedded image file, although it requires some extra tasks. First, he/she creates an image file representing the desired special character. He/she then pastes it on the page that is being edited, by placing a link to the image file. The special characters in the resulting web page can be viewed correctly with any computer systems having different operating environments.

The above-described method, however, can be applied only to static web pages which are produced and edited off-line by a human operator. It is not applicable to such documents that are dynamically compiled in accordance with a database search result, for example, since conventional systems are unable to generate special character images and insert their link information to a document in real time. This inability of conventional systems hinders the full exploitation of existing mainframe database resources mentioned above. It is a time-consuming and labor-intensive task to previously identify all special characters and custom characters used in the database records and replace them with some alternative character codes. Also, the use of alternative characters poses another problem because it sacrifices the accuracy of information.

### SUMMARY OF THE INVENTION

Taking the above into consideration, an object of the present invention is to provide a system which processes special characters used in a dynamic document in real time to make them viewable at a remote computer system.

To accomplish the above objects, according to the present invention, there is provided a system which processes special characters used in a dynamic document intended for exchange over a network. This system comprises a special character image management unit and a document conversion unit. The special character image management unit comprises the following elements: a special character definition unit which creates a special character database file that defines which characters to convert into graphic images; a special character image generator which produces graphical images of the special characters that the definition unit has determined as being relevant to the conversion, with reference to a given character pattern dictionary containing character pattern data; a first image data storage unit which stores the special character database file produced by the special character definition unit and the special character images produced by the special character image generator; and an uploading unit which transmits the special character database file and special character image files to the document conversion unit. The document conversion unit, on the other hand, comprises the following elements: a second image data storage unit which stores the special character database file and special character images received from the uploading unit; a special character identification unit which identifies a special character used in a given source document by consulting the special character database file stored in the second image data storage unit; a link generator which produces a link to one of the special character image files that is relevant to the identified special character; and a compilation unit which compiles an output document by replacing the special character identified in the source document with the link to their corresponding special character images.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a block diagram showing the concept of a special character processing system according to the present invention;

FIG. 2 is a block diagram showing a typical configuration of a database service system operating on the Internet;

FIG. 3 is a diagram showing an example screen shot of the main window of a special character image management program according to the present invention;

FIG. 4 is a diagram showing a typical “SPECIAL CHARACTER DEFINITION” dialog box;

FIG. 5 is a flowchart showing a process of “SPECIAL CHARACTER DEFINITION” dialog;

FIG. 6 is a diagram which shows a typical “IMAGE GENERATION” dialog box;

FIG. 7 is a flowchart showing a process of “IMAGE GENERATION” dialog;

FIG. 8 is a diagram showing a typical “UPLOAD TO SERVER” dialog box;

FIG. 9 is a flowchart showing a process of “UPLOAD TO SERVER” dialog;

FIG. 10 is a flowchart of a document conversion program;

FIG. 11 is a diagram showing a format of special character database files; and

FIG. 12 is a diagram showing a directory storing special character image files in a WWW server.

### DESCRIPTION OF THE PREFERRED EMBODIMENTS

Preferred embodiments of the present invention will be described below with reference to the accompanying drawings.

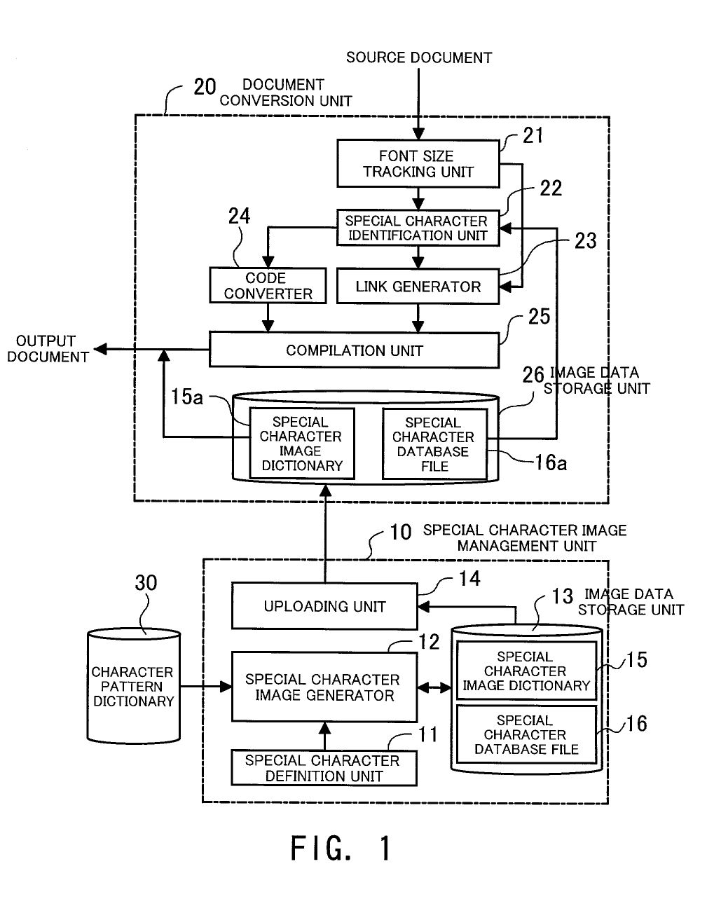

FIG. 1 is a block diagram showing the concept of a special character processing system according to the present invention. This system, comprising a special character image management unit 10 and a document conversion unit 20, processes special characters used in a dynamic document. Typically (although not explicitly shown in FIG. 1), the special character image management unit 10 is employed in a general purpose computer which uses special characters in its local database, while the document conversion unit 20 is located in a server machine which serves remote client systems being incompatible with those special characters.

According to the present invention, the special character image management unit 10 comprises the following elements: a special character definition unit 11, a special character image generator 12, an image data storage unit 13, and an uploading unit 14. The special character definition unit 11 defines which special characters should be converted to graphic images. The special character image generator 12 produces graphical images of special characters that are registered in a character pattern dictionary 30 in the general purpose computer. The image data storage unit 13 stores the produced images. The uploading unit 14 transfers the stored image data from the image data storage unit 13 to the document conversion unit 20. The special character image generator 12 creates a special character image dictionary 15 and special character database file 16 and saves them to the image data storage unit 13.

The document conversion unit 20 comprises a font size tracking unit 21, a special character identification unit 22, a link generator 23, a code converter 24, a compilation unit 25, and an image data storage unit 26. When a specific source document is given, the font size tracking unit 21 finds character size attribute information in the source document and maintains that information locally. The special character identification unit 22 identifies special characters appearing in the document data. The link generator 23 produces links to image files of the identified special characters. The code converter 24 converts character codes of the source document when the coding system originally used in the document differs from what client systems would accept. The compilation unit 25 combines the outcomes of the link generator 23 and code converter 24, thereby compiling an output document of the document conversion unit 20. The image data storage unit 26 stores a local copy of the special character image dictionary 15 and special character database file 16 transferred from the special character image management unit 10. In FIG. 1, these replicas are designated by modified reference numerals, i.e., special character image dictionary 15a and special character database file 16a.

More specifically, the special character image management unit 10 operates as follows. The special character definition unit 11 defines the range of character codes to be imaged, font sizes, and image file storage location. Based on this definition, the special character image generator 12 creates a special character database file 16 which contains a special character code list and information about image sizes. The special character image generator 12 then generates a graphic image of each specified special character, reading out its character pattern from a given character pattern dictionary 30. Repeating this procedure for all the specified size variations, the special character image generator 12 produces a special character image dictionary 15 that contains the generated graphic images. In addition to the above features, this special character image generator 12 is capable of preparing graphic images of the entire special character set registered in the character pattern dictionary 30. It can also generate images solely of such characters that have been newly added or modified. The special character image dictionary 15 and special character database file 16 created in this way are transferred 14 to the document conversion unit 20 through the uploading unit. The document conversion unit 20 stores the received data in its local image data storage unit 26 as a special character image dictionary 15a and special character database file 16a.

Suppose here that the document conversion unit 20 is given a certain source document. Sequentially parsing its tagged text, the font size tracking unit 21 determines what font size is currently used and keeps that information as a “current font size” parameter. If a new font size is encountered in the course of the text parsing, the font size tracking unit 21 updates the current font size with the new value. The special character identification unit 22 then makes access to the special character database file 16a in the image data storage unit 26 to read the special character code list, sizes of special character images, and directory path that tells where the image data is stored. Comparing this information with the code and size of each character in the source document, the special character identification unit 22 determines whether the character is among those being registered in the special character image dictionary 15a. The characters determined as being normal ones (i.e., non-special characters) are directed, if necessary, to the code converter 24 to change their codes. When a character is identified as being a special character, the link generator 23 refers to the current font size maintained in the font size tracking unit 21 and creates a link to a graphic image file that represents the identified special character with the current font size. The compilation unit 25 replaces the special character code in the source document with the created link, thus outputting the modified document text. The document text processed in this way can now be viewed with a browser program, its special character portions being represented in the form of graphic images with the font size specified in the original source document.

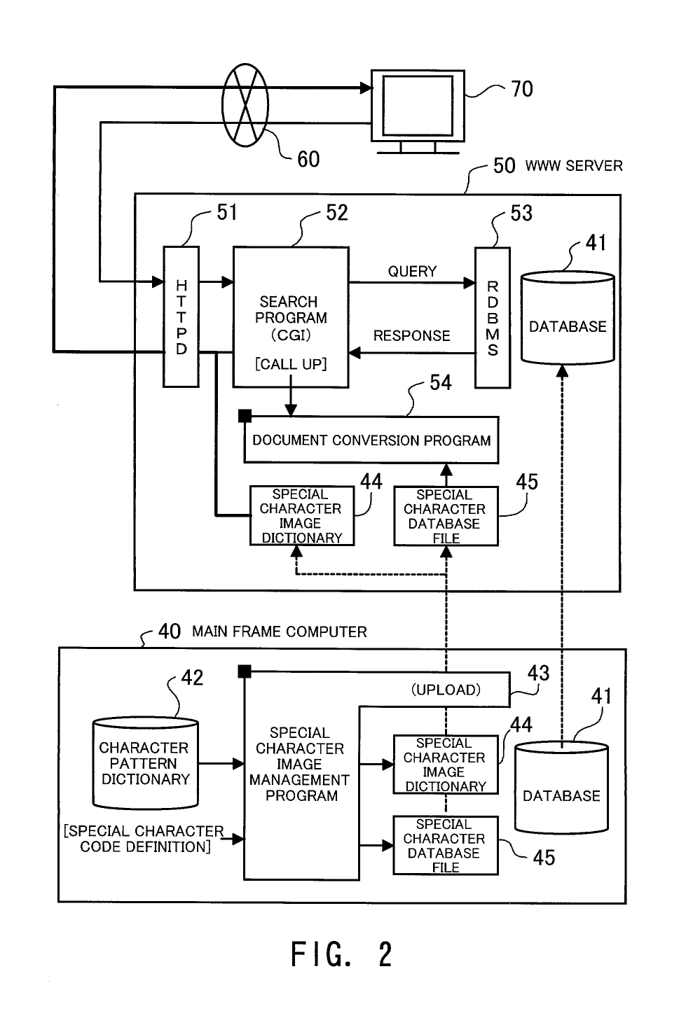

A more specific embodiment based on the above-described concept of the present invention will now be described below. FIG. 2 is a block diagram showing a typical configuration of an Internet-based database service system. The illustrated system is organized by the following subsystems: a main frame computer 40 which maintains its local database; a WWW server 50 which offers a database access service to allow public access to the database in the main frame computer 40, and a personal computer 70 connected to the WWW server 50 via the Internet 60. Using a WWW browser program (not shown) installed in the personal computer 70, the user can visit the homepage of the database access service provided by the WWW server 50.

The main frame computer 40 comprises a database 41, a character pattern dictionary 42 which stores all character patterns used in this database 41, and a special character image management program 43. The special character image management program 43 generates graphic images of special characters, reading out the character patterns of the specified codes. The resulting image data is then stored in the special character image dictionary 44. The special character image management program 43 also produces a special character database file 45 to maintain the information about the generated special character images. If requested, the special character image management program 43 supplies the WWW server 50 with a copy of its local special character image dictionary 44 and special character database file 45.

The WWW server 50 comprises a document transfer program 51 (HTTPD), a search program 52, a database management program 53 (RDBMS), and a document conversion program 54. The database 41 of the main frame computer 40 is replicated intact in this WWW server 50. The WWW server 50 also has a copy of the special character image dictionary 44 and special character database file 45 that have been sent from the main frame computer 40. The WWW server 50 provides web pages written in the Hyper Text Markup Language (HTML). The document transfer program 51 contains Hyper Text Transfer Protocol Demon (HTTPD) functions to send and receive such HTML documents. The search program 52, serving as the front-end of the search engine, provides Common Gateway Interface (CGI) functions which enable an HTML document to interact with other programs written in existing programming languages. The database management program 53 is a relational database management system (RDBMS) to control access to the database 41.

To allow retrieval of a record containing special characters, the main frame computer 40 has to prepare a special character image dictionary 44 and a special character database file 45. This is accomplished by running a special character image management program 43. All characters used in the main frame database 41, which include the Japanese Industrial Standards (JIS) level-1 and level-2 fonts and special characters, are found in the character pattern dictionary 42 in the main frame computer 40. While it is not necessary for the main frame computer 40 to generate graphic images for the JIS standard fonts because the personal computer 70 supports them, the other, non-standard characters (i.e., special characters) should be converted into graphic images to make them viewable on the personal computer 70. To this end, the special character image management program 43 has to be given the information (e.g., code and font size) about such special characters, along with the file name of the character pattern dictionary 42. From the character patterns read out of the character pattern dictionary 42, the special character image management program 43 produces images individually for every special character code and for every font size. The generated character images are accumulated in the special character image dictionary 44, being encoded into the Graphics Interchange Format (GIF) standard files. At that time, the association between the character codes and graphic image files is also recorded in the special character database file 45. When the above image generation process is finished for all available special characters, the special character image management program 43 transfers the resultant special character image dictionary 44 and special character database file 45 to the WWW server 50.

Suppose here that the user sitting at the personal computer 70 is attempting access to the homepage of the database access service by sending its Uniform Resource Locator (URL). In response to this request, the WWW server 50 supplies relevant web page data back to the personal computer 70, which allows the user to enter specific search keywords. The specified keywords are then passed to the WWW server 50, causing its internal search program 52 to send a query message containing the keywords to the database management program 53. Using those keywords, the database management program 53 retrieves relevant records from the database 41 and sends them back to the search program 52. The search program 52 compiles an HTML document with that search result and calls up the document conversion program 54. The document conversion program 54 first opens the special character database file 45 to read out the information about special character images and then begins scanning the compiled HTML document to determine what font sizes are specified in its tag fields. The document conversion program 54 keeps and uses this font size information to retrieve necessary special character images with appropriate sizes from the special character database file 45. The document conversion program 54 replaces every special character used in the HTML document with a piece of link information that points at its corresponding special character image file. In parallel to this replacement task, the document conversion program 54 translates between different character coding systems if the current system is not compatible with the personal computer 70. Consider, for example, that the original HTML document is encoded in the JEF graphic code, which the main frame computer 40 uses, but the personal computer 70 does not. In this case, the document conversion program 54 performs code conversion from JEF to Shift-JIS, the latter being compatible with the personal computer 70.

Through the above processing, the HTML document describing the search result has been reformed so that all special character codes contained in the document will be replaced with graphic images embedded in its text part. The WWW browser on the personal computer 70 will now be able to display this HTML document correctly.

The next section will focus on the special character image management program 43. The primary functions of this program 43 are: (a) defining which special characters need to be converted into images; (b) generating special character images according to a special character list created from that definition; and (c) uploading the resulting special character image dictionary 44 and special character database file 45 to the WWW server 50. The details of those functions will be explained below.

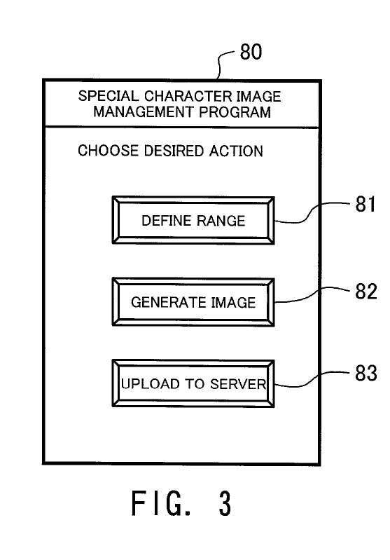

The special character image management program 43 provides its main window and several dialog boxes to interact with a main frame operator. FIG. 3 shows an example screen shot of the main window of the special character image management program 43. This main window 80 provides three on-screen buttons allowing the operator to select and send a desired task command to the program 43. They are: “DEFINE RANGE” button 81, “GENERATE IMAGE” button 82, and “UPLOAD TO SERVER” button 83. Pressing the DEFINE RANGE button 81 calls up a SPECIAL CHARACTER DEFINITION dialog where the operator can define which special characters to convert. The GENERATE IMAGE button 82 triggers an IMAGE GENERATION dialog where image generation for the specified special characters takes place. The UPLOAD TO SERVER button 83 invokes an UPLOAD TO SERVER dialog where the generated image files are transferred to the WWW server 50.

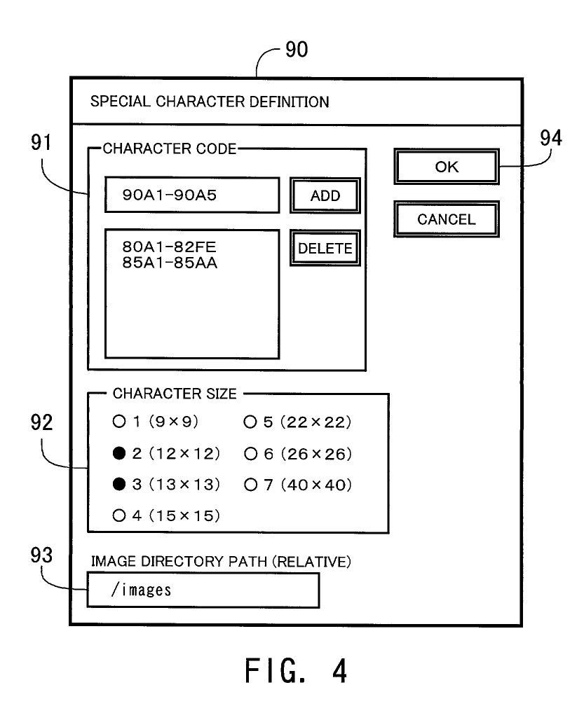

Referring to FIG. 4, a typical SPECIAL CHARACTER DEFINITION dialog box is shown. This dialog box 90 has the following data entry areas: a character code entry area 91 for specifying special characters that need to be converted into graphic images; character size options 92 for specifying the size of images, and an image path entry box 93 for specifying where to store the character images. More specifically, the operator enters a specific range of character codes into the topmost text box and clicks the “ADD” button. The entered new code range then appears in the list box just below the text box. By repeating the above, the operator will have created a list of code ranges. The “DELETE” button in the area 91 allows the operator to remove an existing list entry. The character size options 92 are selected or deselected by clicking relevant radio buttons (i.e., round option buttons). Each character enumerated in the special character code list is to be converted into a graphic image with a specified size. Note that a plurality of character images with different sizes will be generated for each individual code within the specified range(s) if the operator selects two or more character size options at a time. With the image path entry box 93, the operator specifies a directory (or folder) where the generated image files are to be stored to form a special character image dictionary 44. The WWW server 50 uses this information as an image directory path relative to its home directory. After completing the above data entry, the operator presses the OK button 94 to return to the main window 80.

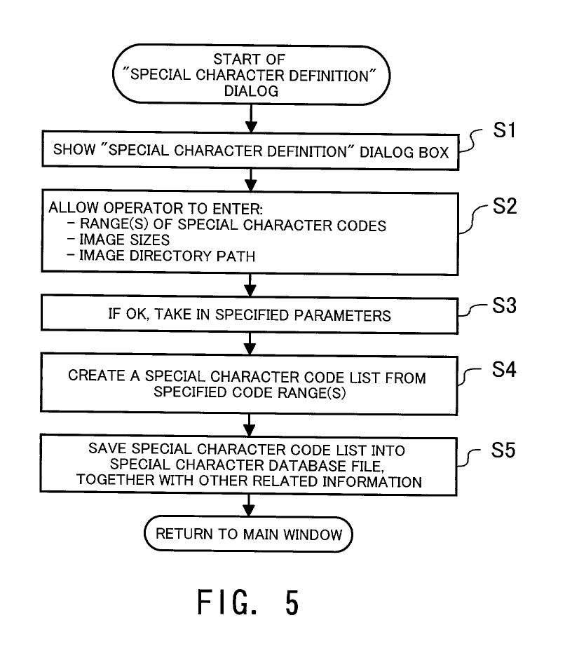

Referring to the flowchart of FIG. 5, the special character image management program 43 controls the above-described dialog box 90 in the following way. In the main window 80 (FIG. 4), the operator presses the “DEFINE RANGE” button 81. This triggers the special character image management program 43 to show a SPECIAL CHARACTER DEFINITION dialog box 90 (step S1), allowing the operator to specify the range(s) of special character codes, image sizes, and image directory path (step S2). When the OK button 94 is pressed, the special character image management program 43 takes in the parameters that the operator has specified in the dialog box 90 (step S3). The special character image management program 43 now creates a special character code list from the specified parameters (step S4) and saves it into the special character database file 45, together with the image sizes and image directory path information (step S5). The special character image management program 43 then closes the dialog 90, thus returning the focus to the main window.

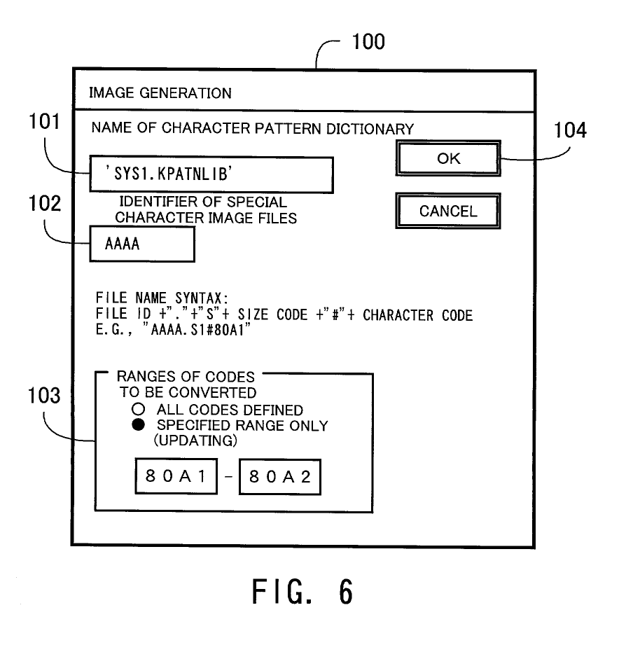

FIG. 6 shows a typical IMAGE GENERATION dialog box. This dialog box 100 provides the following data entry areas: a text box 101 for specifying the file name of a character pattern dictionary 42 stored in the main frame computer 40; another text box 102 for specifying a file identifier that is used to determine the name of each special character image file; and a group box 103 for specifying whether to convert all the predefined character ranges or a particular range among them. Every image file is designated by a name consisting of the following components: predetermined file identifier, period (.), alphabet “S,” size code, pound sign (#), and character code. Those components are concatenated in that order, which uniquely identifies each character image. An image file named “AAAA.S1#80A1,” for example, contains the graphic image of a special character that is designated by a character code of “80A1” and has a size code of “1.” The operator checks the above items and presses the OK button 104 to return to the main window 80.

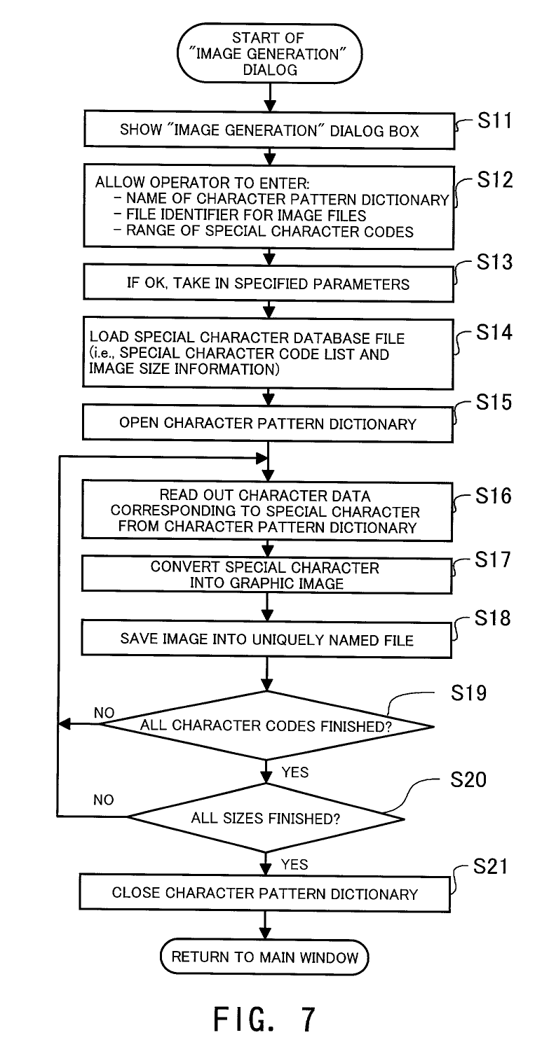

Referring to the flowchart of FIG. 7, the special character image management program 43 controls the above-described dialog box 100 in the following way. In the main window 80 (FIG. 4), the operator presses the GENERATE IMAGE button 82. This requests the special character image management program 43 to make an IMAGE GENERATION dialog box 100 pop up (step S11), allowing the operator to specify a character pattern dictionary, file identifier for image files, and the range of special character codes (step S12). At step S12, the operator can direct the system to convert either all the code ranges previously specified in the SPECIAL CHARACTER DEFINITION dialog box 90, or a particular range of codes. After checking the parameters that he/she has entered, the operator presses the OK button 104, which causes the parameters to be taken into the special character image management program 43 (step S13). The management program 43 then loads the special character code list and size information from the special character database file 45 into the memory (step S14) and opens the character pattern dictionary 42 in read mode (step S15). Reading out relevant character data from the character pattern dictionary 42 (step S16), the special character image management program 43 converts a special character into a graphic image with a specified size (step S17) and saves the result into a file that is named after the original character's code and size (step S18). The above steps S16 through S18 are repeated for each individual special character specified in the special character code list, or for each character that falls within the code range specified in the IMAGE GENERATION dialog box 100 (step S19). Note that this processing loop covers only one font size, and if necessary, the steps S16 to S19 should be repeated to deal with different character sizes (step S20). The image files produced in this way form a special character image dictionary 44. Finally, the special character image management program 43 closes the character pattern dictionary 42 (step S21), thus returning the focus to the main window.

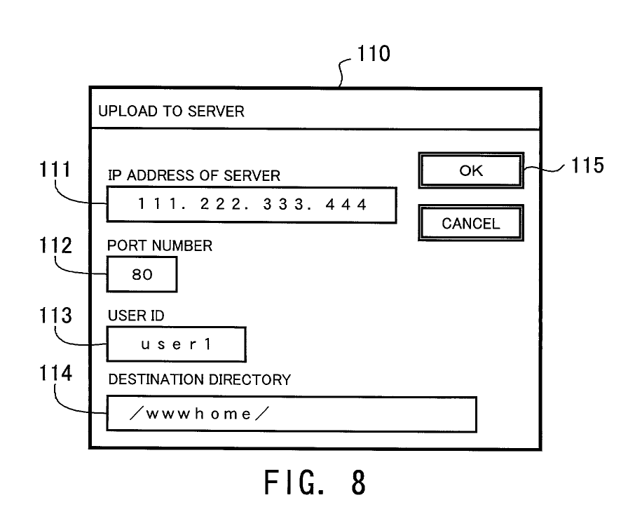

Referring to FIG. 8, a typical UPLOAD TO SERVER dialog box is shown. This UPLOAD TO SERVER dialog box 110 is designed to send the special character image dictionary 44 and special character database file 45 to the WWW server 50 with the file transfer protocol (ftp). It provides the following data entry areas: a text box 111 for specifying the IP address of the WWW server 50, another text box 112 for specifying the port number, still another text box 113 for specifying the user ID, and yet another text box 114 for specifying the directory where the special character image dictionary 44 and special character database file 45 will be stored. The operator enters the above items and presses the OK button 115 to return to the main window 80.

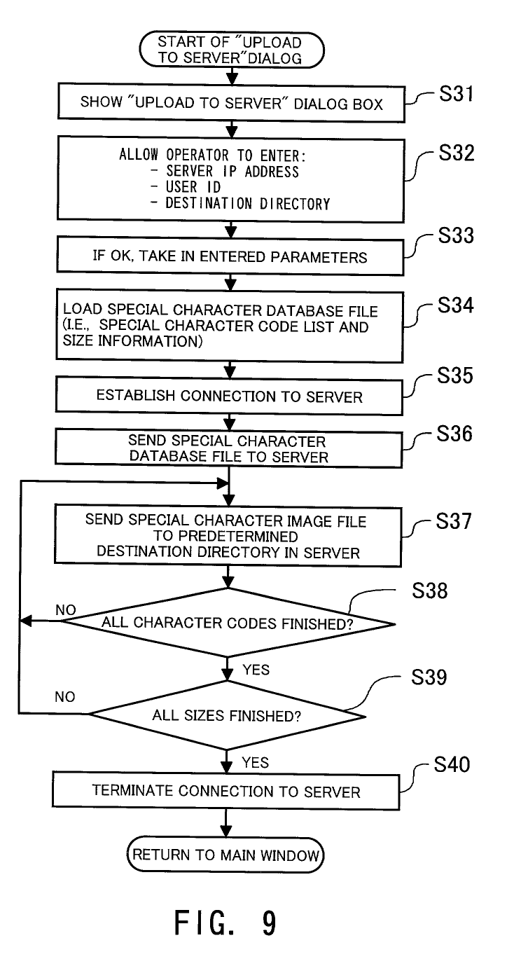

Referring to the flowchart of FIG. 9, the special character image management program 43 controls the UPLOAD TO SERVER dialog box 110 in the following way. In the main window 80 (FIG. 4), the operator presses the “UPLOAD TO SERVER” button 83. This triggers the special character image management program 43 to initiate an UPLOAD TO SERVER dialog box 110 (step S31), allowing the operator to specify the IP address, user ID, and destination directory (step S32). After checking the parameters that he/she has entered, the operator clicks the OK button 115, which causes those parameters to be taken into the special character image management program 43 (step S33). The management program 43 then reads the special character code list and size information from the special character database file 45 (step S34), establishes a connection to the WWW server 50 (step S35), and sends the special character database file 45 to the WWW server 50 (step S36). The management program 43 transmits a special character image file with a certain size to the predetermined destination directory in the WWW server 50 (step S37). When the image file transmission for a particular character size is completed (step S38), the special character image management program 43 repeats the same for the next character size, if any (step S39). In this way, the special character image management program 43 supplies the WWW server 50 with the special character images of all sizes. It then terminates the connection with the WWW server 50 (step S40) and returns to the main window 80.

While the above sections have described the special character image management program 43, the focus will now be shifted to the document conversion program 54 in the WWW server 50. This document conversion program 54 scans each HTML document produced by the search program 52 to find special characters used in it. If it encounters a character code that is registered in the special character database file 45, the document conversion program 54 replaces it with a link to its corresponding image file. By repeating that, the program 54 converts the document into such a form where the special characters are represented as graphical images embedded in the text. The details of this document conversion program 54 will now be discussed below.

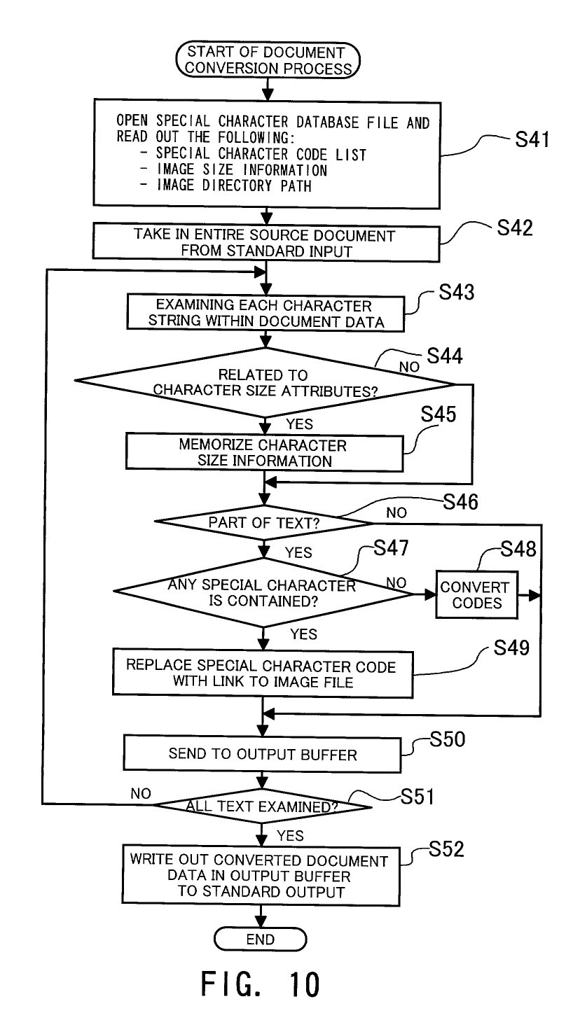

Referring to the flowchart of FIG. 10, the document conversion program 54 first opens the special character database file 45 when it is called by the search program 52. Out of this database file 45, the document conversion program 54 reads out the special character code list, image size information, and image directory path and loads them to the main memory (step S41). After that, it takes in a source HTML document from the standard input until the end of file is found (step S42). Examining each character string within the document data (step S43), the document conversion program 54 determines whether it is related to character size attributes (step S44). If the character string is determined to be this kind of information (i.e., if it is a font size code), the document conversion program 54 memorizes the information (step S45). If not, it proceeds to step S46, skipping step S45. The document conversion program 54 then determines whether the character string in question is part of the text, by parsing the surrounding tags (step S46). If the character string is not a text part, the program 54 simply sends it to the output buffer (step S50). If it turns out to be a text part, the program 54 then compares each character code with the special character code list, thereby determining whether any special character is contained in the string (step S47). If the character falls within the standard characters (i.e., JIS level-1 and -2 character sets), the document conversion program 54 sends it to the output buffer, converting the code from JET to Shift-JIS if necessary (step S48). If the character is a special character, the document conversion program 54 replaces its code in the string with a link to an image file representing that special character with the current font size (step S49). Besides providing the name of the special character image file, the link information includes the path to the image file directory. The character string modified as such is then sent to the output buffer (step S50). The above steps S43 to S50 are repeated until the end of the source document is reached (step S51). Lastly, the document conversion program 54 writes out the converted document data in the output buffer to the standard output (step S52), thus providing a fully viewable document which contains special character images being pasted on where their original character codes were located.

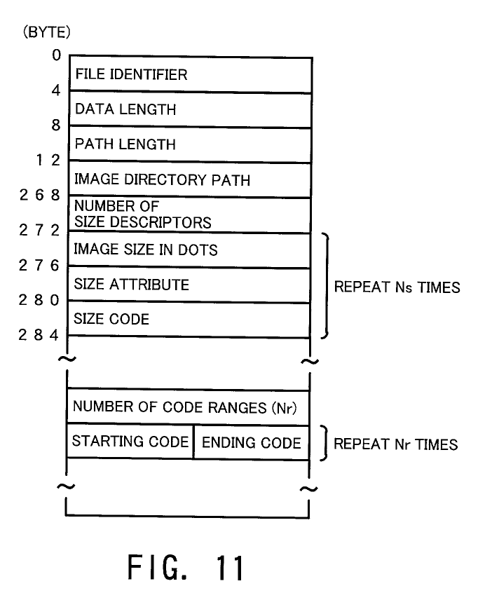

Referring next to FIG. 11, a typical format of the special character database file 45 is shown. This file 45 contains the following data items:

File identifier indicating the identity of the special character database file 45

Total length of the file data

Length of the pathname that immediately follows

Relative path pointing at the special character image directory

Number of size descriptors that immediately follow

Image size in dots

Size attribute indicating the font size of text in the document

Size code used to classify image files

Number of code ranges that immediately follow

Code ranges, each consisting of a starting code and an ending code

The combination of “Image size,” “Size attribute,” and “Size code” is referred to herein as a “size descriptor.” Those three fields are repeated in that order, as many time as described in the “Number of size descriptors” field. Each code range is defined as the combination of a particular starting code and ending code. These code fields are repeated as many times as described in the “Number of code ranges” field.

Referring back to FIG. 2, the special character image dictionary 44 is composed of multiple image files each representing a single special character. As previously described, the main frame computer 40 creates those image files in the GIF format and names them originally as follows.

“image file identifier”+“.”+“S”+“size code”+ “#”+“character code”

When the main frame computer 40 transfers the image files to the WWW server 50, they are renamed as follows.

“character code”+“size code”+“.”+“file extension.”

Take an image file “AAAA.S1#80A1” on the main frame computer 40, for example. This file will be given a new name of “80a11.gif” on the WWW server 50, meaning that it is a GIF image file with a character code of “10a1” and a size code of “1.”

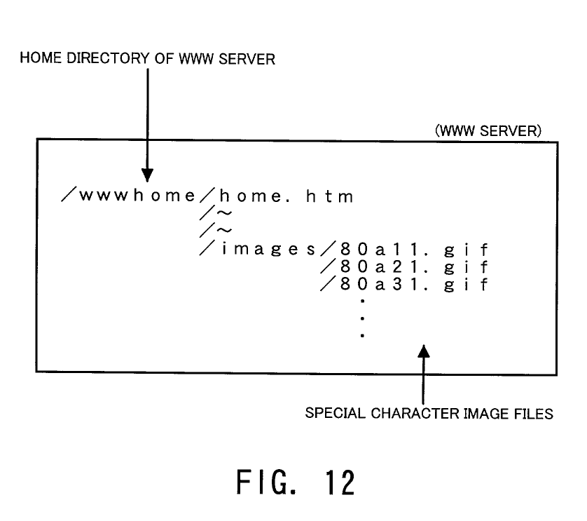

FIG. 12 shows a directory storing special character image files in a WWW server. Recall the SPECIAL CHARACTER DEFINITION dialog box 90 of FIG. 4, where the operator has specified “/images” as the relative path of the special character image directory. Also recall that he/she has specified in the UPLOAD TO SERVER dialog box 110 of FIG. 8 in such a way that image files be stored under the home directory “/wwwhome/” of the WWW server 50. As a result of those setups, the storage location of image files is determined to be “/wwwhome/images” in the WWW server 50. Consider here that a web page document file named “home.htm” is stored in the home directory “/wwwhome” of the WWW server 50. Then the name of a special character image file “80a11.gif,” for example, will appear in this document file in the following image insertion tag.

<img src=“images/80a11.gif”>

This tag information has been inserted within the text part to replace a special character code “80a1.”

In the way described above, according to the present invention, a document retrieved from a database is converted into another form where all special characters contained therein are replaced with their respective graphic images. As a result, the WWW browser on the personal computer 70 can display those special characters as inline images within the text of the document.

The process steps of the proposed systems are encoded in the form of computer programs, which will be stored in a computer-readable storage medium. The computer systems execute those programs to provide the intended functions of the present invention. Suitable computer-readable storage media include magnetic storage media and solid state memory devices. Other portable storage media, such as CD-ROMs and floppy disks, are particularly suitable for circulation purposes. Further, it will be possible to distribute the programs through an appropriate server computer deployed on a network. The program files delivered to a user are normally installed in his/her computer's hard drive or other local mass storage devices, which will be executed after being loaded to the main memory.

The above discussion will now be summarized as follows. According to the present invention, the proposed system replaces special character codes in a dynamic document with appropriate links to system-independent special character image files. This feature enables the search engines and other Internet-based database applications to provide the users with search results containing special characters, thus improving the quality of their services.

The present invention also promotes the full use of existing mainframe databases over the Internet, since it reduces the amount of labor that is required to make those resources available on a server machine. It is no longer necessary to change each special character code manually. According to the present invention, database records in a mainframe computer can be exported almost directly to the database server for public use.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A system for processing special characters used in a dynamic document intended for exchange over a network, comprising:
(a) a special character image management unit comprising:
special character definition means for creating a special character database file that defines which characters to convert into graphic images,
special character image generation means for producing graphical images of the special characters that said definition means has determined as being relevant to the conversion, with reference to a given character pattern dictionary containing character pattern data,
first image data storage means for storing the special character database file produced by said special character definition means and the special character images produced by said special character image generating means, and
uploading means for transmitting the special character database file and the special character image files; and
(b) a document conversion unit comprising:
second image data storage means for storing the special character database file and special character images received from said uploading means,
special character identification means for identifying a special character used in a given source document by consulting the special character database file stored in said second image data storage means,
link generation means for producing a link to one of the special character image files that is relevant to the identified special character, and
compilation means for compiling an output document by replacing the special character identified in the source document with the link to the corresponding special character image file.

2. The system according to claim 1, wherein said special character definition means defines character codes and character sizes of the special characters to be converted.

3. The system according to claim 2, wherein said special character image generation means produces one special character image file for each identified special character, based on the character pattern data read out of the given character pattern dictionary.

4. The system according to claim 2, wherein said special character image generation means produces as many special character image files as the number of different character sizes for each identified special character, based on the character pattern data read out of the given character pattern dictionary.

5. The system according to claim 4, wherein said special character image generation means assigns a file name to each produced special character image file, the file name comprising text fields that indicate the character code and the character size, whereby an appropriate special character image file can be uniquely and immediately identified by a given character code and character size.

6. The system according to claim 1, wherein said document conversion unit further comprises font size tracking means for finding character size attribute information in the given source document and maintains the extracted information locally.

7. The system according to claim 6, wherein said link generation means produces a link to one of the special character image files that meets the special character code identified by said special character identification means and the character size attribute information maintained in said font size tracking means.

8. The system according to claim 1, wherein said document conversion unit further comprises code conversion means for converting a character code used in the given source document into another character code belonging to a required coding system, when the character code is identified as a non-special character by said special character identification means.

9. A document conversion unit which dynamically creates a document from data retrieved from a processing system that uses special characters and reforms the created document for exchange over a network, comprising:
a special character image dictionary which is a collection of special character image files each containing a graphic image of a special character;
a special character database file which contains data to manage the special character image files in said special character image dictionary;
special character identification means for identifying a special character used in the created document, by consulting the special character database file;
link generation means for producing a link to one of the special character image files that is relevant to the identified special character; and
compilation means for compiling an output document by replacing the special characters identified in the source document with the links to the special character images.

10. The apparatus according to claim 9, further comprising font size tracking means for extracting character size attribute information from the created document and keeps the extracted information locally.

11. The apparatus according to claim 10, wherein said link generation means produces a link to one of the special character image files that meets the special character code identified by said special character identification means and the character size attribute information maintained in said font size tracking means.

12. The apparatus according to claim 9, further comprising code conversion means for converting a character code used in the created document into another character code belonging to a required coding system, when the character code is identified as a non-special character by said special character identification means.

13. A computer-readable medium storing a program which processes special characters contained in a dynamic document created for exchange over a network, the program causing a computer system to function as:
special character definition means for determining which characters to convert into graphic images, thereby producing a special character database file;
special character image generation means for producing graphical images of the special characters that said definition means has determined as being relevant to the conversion, with reference to a given character pattern dictionary containing character pattern data;
uploading means for transmitting the special character database file and the special character image files;
font size tracking means for extracting character size attribute information from a given source document and keeps the extracted information locally;
special character identification means for identifying a special character used in the given source document by consulting the special character database file stored in said second image data storage means,
link generation means for producing a link to one of the special character image files that is relevant to the identified special character;
code conversion means for converting a character code used in the created document into another character code belonging to a required coding system, when the character code is identified as a non-special character by said special character identification means; and
compilation means for compiling an output document by replacing the special character identified in the source document with the link to the corresponding special character image file.
